(19) United States
(12) Patent Application Publication
(10) Pub. No.: US 2014/0111419 A1
(43) Pub. Date: Apr. 24, 2014

(54) INFORMATION PROCESSING APPARATUS, INFORMATION PROCESSING METHOD, AND COMPUTER PROGRAM PRODUCT

(71) Applicant: KABUSHIKI KAISHA TOSHIBA, Tokyo (JP)

(72) Inventor: Masahiro Takayama, Tokyo (JP)

(73) Assignee: KABUSHIKI KAISHA TOSHIBA, Tokyo (JP)

(21) Appl. No.: 13/951,288

(22) Filed: Jul. 25, 2013

(30) Foreign Application Priority Data
Oct. 23, 2012 (JP) 2012-234030

(51) Int. Cl. G06F 3/01

(52) U.S. Cl. CPC G06F 3/01
USPC 345/156

(57) ABSTRACT

According to one embodiment, an information processing apparatus includes: a display comprising a screen; a detector configured to detect a first state of the screen when the screen is faced down; and a controller configured to initiate a security locked mode when the first state is detected.

### CROSS-REFERENCE TO RELATED APPLICATIONS

This application is based upon and claims the benefit of priority from Japanese Patent Application No. 2012-234030, filed Oct. 23, 2012, the entire contents of which are incorporated herein by reference.

### FIELD

Embodiments described herein relate generally to an information processing apparatus, an information processing method, and a computer program product.

### BACKGROUND

Information processing apparatuses in a slate shape comprising a screen such as a tablet personal computer (PC) comprise a known technology in which the screen is turned down is detected and the operation mode is switched between a used mode and a not-in-use mode.

In this conventional technology, when the screen is turned down is detected, the operation mode is switched to the not-in-use mode, for the purpose of reducing the power consumption of a battery comprised in the information processing apparatus. After that, when an information processing apparatus is returned to the state in which the screen faces up, the operation mode is switched to the used mode, which can leak the information displayed on the screen, however.

### BRIEF DESCRIPTION OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary schematic external view of an information processing apparatus according to an embodiment;

FIG. 2 is an exemplary block diagram of the hardware structure of the information processing apparatus in the embodiment;

FIG. 3 is an exemplary block diagram of the function structure of the information processing apparatus in the embodiment;

FIG. 4 is an exemplary diagram for explaining the state in which the screen on the information processing apparatus in the embodiment is faced down; and

FIG. 5 is an exemplary flowchart of processing of transition to a security locked mode in the information processing apparatus in the embodiment.

### DETAILED DESCRIPTION

In general, according to one embodiment, an information processing apparatus comprises: a display comprising a screen; a detector configured to detect a first state of the screen when the screen is faced down; and a controller configured to initiate a security locked mode when the first state is detected.

An information processing apparatus, a method of transition to a security locked mode, and a computer program according to the embodiment will be described below in detail with reference to the accompanying drawings. An information processing apparatus comprising a slate housing such as a personal digital assistant (PDA) and a mobile phone is exemplified in the embodiment below.

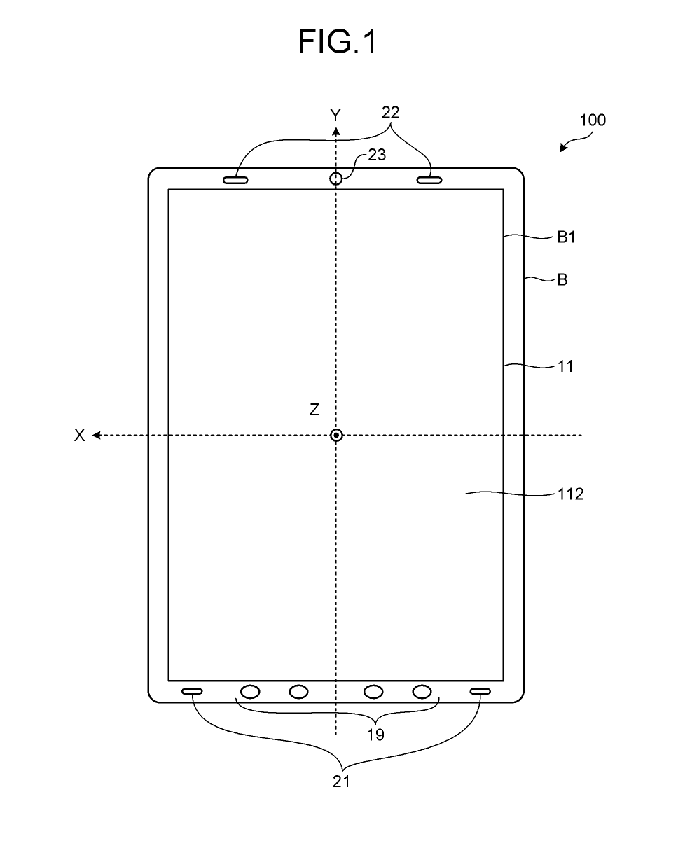

FIG. 1 is a schematic external view of the information processing apparatus according to the embodiment. This information processing apparatus 100 is an information processing apparatus in a slate shape comprising a display 11 that comprises a screen 112. The information processing apparatus 100 is achieved as, for example, a slate terminal (tablet terminal), an electronic book reader, and a digital photo frame. The arrowed directions of the X-axis, the Y-axis, and the Z-axis (the arrowed direction of the Z-axis indicates the front direction in FIG. 1) represent positive directions.

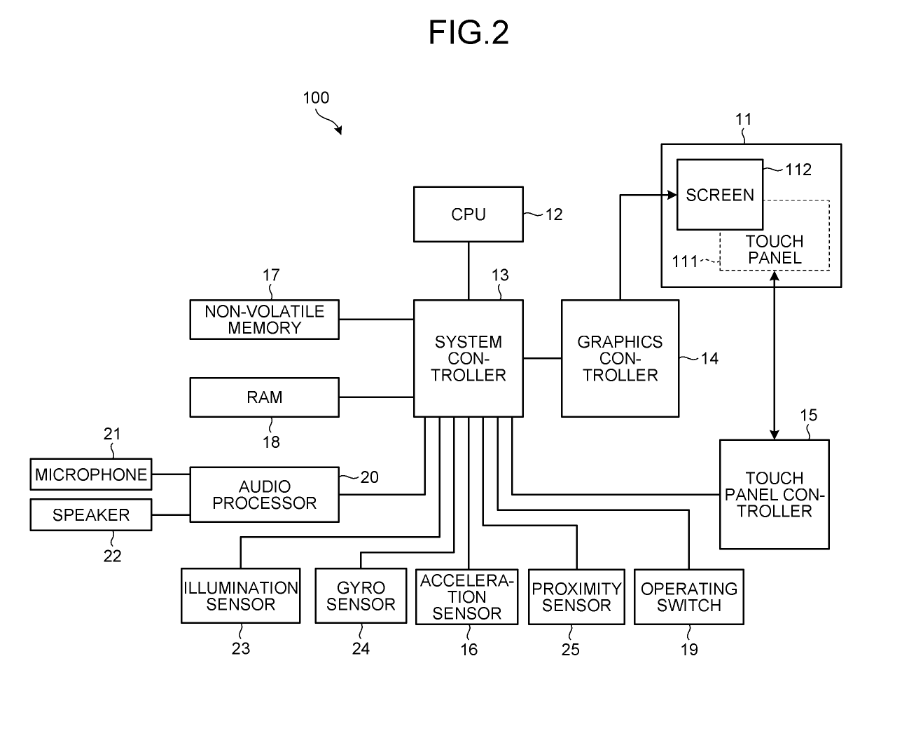

The information processing apparatus 100 comprises a housing B in a thin-box (slate) shape that houses the display 11. The housing B in the embodiment comprises a plane (hereinafter, referred to as an upper surface) comprising an opening B1 that exposes the screen 112 comprised in the display 11. The display 11 comprises a touch panel 111 (refer to FIG. 2) detecting the position on the screen 112 touched by a user. Operating switches 19 and microphones 21 are provided on the bottom part on the upper surface of the housing B. The operating switches 19 are used for various operations by a user and the microphones 21 obtain user's voice. Speakers 22 are provided on the top part on the upper surface of the housing B, which output audio from the information processing apparatus 100. A connector (not illustrated) is provided on an edge of the housing B, which can be used to couple a pair of headphones or a pair of earphones to the information processing apparatus 100. An illumination sensor 23 is also provided on the top part on the upper surface of the housing B, which detects the surrounding brightness of the information processing apparatus 100.

FIG. 2 is a block diagram of the hardware structure of the information processing apparatus according to the embodiment. As illustrated in FIG. 2, the information processing apparatus 100 in the embodiment comprises a central processing unit (CPU) 12, a system controller 13, a graphics controller 14, a touch panel controller 15, an acceleration sensor 16, a non-volatile memory 17, a random access memory (RAM) 18, an audio processor 20, a gyro sensor 24, and an proximity sensor 25 in addition to the components described above.

The display 11 comprises the touch panel 111 and the screen 112 comprising a liquid crystal display (LCD) or an organic light emitting display (OLED). The touch panel 111 is provided on the screen 112 and serves as a coordinate sensor, for example. The touch panel 111 detects the position (touched position) on the screen 112 touched with a finger of a user grasping the housing B.

The CPU 12 controls the modules in the information processing apparatus 100 through the system controller 13. The CPU 12 executes an operating system and various application programs such as a web browser and a software program used for writing, loaded from the non-volatile memory 17 to the RAM 18.

The non-volatile memory 17 stores therein an operating system, various application programs or other computer programs, and various types of data. The RAM 18 provides a working area for the CPU 12 to execute a computer program.

The system controller 13 comprises therein a memory controller that accesses and controls the non-volatile memory 17 and the RAM 18. The system controller 13 comprises a function to communicate with the graphics controller 14.

The graphics controller 14 serves as a display controller and controls the screen 112. The touch panel controller 15 controls the touch panel 111 and obtains therefrom the coordinate data indicating the touched position by a user on the screen 112.

The illumination sensor 23 is a photodiode, for example, and detects the surrounding brightness of the information processing apparatus 100. The illumination sensor 23 in the embodiment is provided on the upper surface of the housing B as described above, and outputs to the CPU 12 a brightness signal that indicates the brightness in the front of the screen 112, that is, the surrounding brightness of the information processing apparatus 100.

The gyro sensor 24 detects a rotation angle when the information processing apparatus 100 rotates around the X-axis, the Y-axis, or the Z-axis. The gyro sensor 24 then outputs a rotational angle signal that indicates the rotation angle around the X-axis, the Y-axis, or the Z-axis to the CPU 12.

The acceleration sensor 16 detects accelerations of the information processing apparatus 100. The acceleration sensor 16 in the embodiment detects the accelerations in the directions of the X-axis, the Y-axis, and the Z-axis, and the accelerations in the rotational directions around the X-axis, the Y-axis, and the Z-axis illustrated in FIG. 1. The acceleration sensor 16 then outputs to the CPU 12 an acceleration signal indicating the accelerations in the directions of the X-axis, the Y-axis, and the Z-axis, and the accelerations in the rotational directions around the X-axis, the Y-axis, and the Z-axis illustrated in FIG. 1.

The proximity sensor 25 detects proximity of a target object in a contactless manner. Specifically, the proximity sensor 25 employs a high frequency oscillation, a magnetic, or an electrostatic capacitive sensor. The high frequency oscillation sensor utilizes electromagnetic induction and the magnetic sensor uses a magnet. The electrostatic capacitive sensor detects changes of electrostatic capacity between the target object and itself. When the proximity sensor 25 detects that the target object comes close, the proximity sensor 25 outputs to the CPU 12 a proximity signal that indicates proximity of the target object.

The audio processor 20 performs audio processing such as digital conversion, noise removal, and echo cancellation on an audio signal input from the microphones 21 and outputs the resulting signal to the CPU 12. The audio processor 20 also outputs to the speakers 22 an audio signal generated through audio processing such as audio composition under the control of the CPU 12.

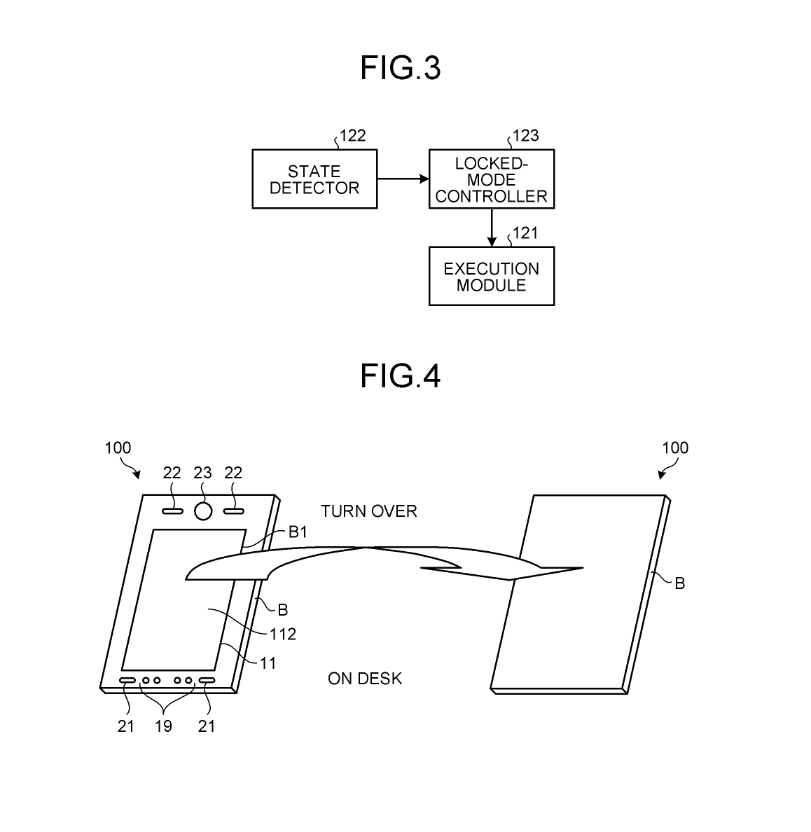

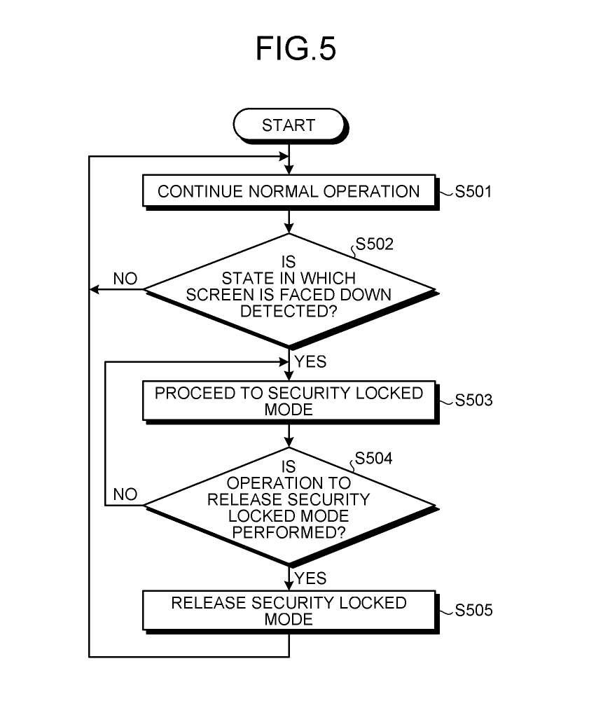

The function structure of the information processing apparatus 100 in the embodiment will now be described with reference to FIGS. 3 to 5. FIG. 3 is a block diagram of the function structure of the information processing apparatus according to the embodiment. FIG. 4 is a diagram for explaining the state in which the screen on the information processing apparatus in the embodiment is faced down. FIG. 5 is a flowchart of processing of transition to the security locked mode in the information processing apparatus in the embodiment.

As illustrated in FIG. 3, the CPU 12 executes a computer program stored in the non-volatile memory 17 so as to implement an execution module 121, a state detector 122, and a locked-mode controller 123 in the information processing apparatus 100.

The execution module 121 executes various application programs stored in the non-volatile memory 17. The execution module 121 executes the application programs involving display of information, replay of audio, and replay of video, for example, in the embodiment.

The state detector 122 functions as a detector that detects the state in which the screen 112 on the information processing apparatus 100 is faced down. The state detector 122 in the embodiment detects the state in which the screen 112 is faced down based on a rotation angle indicated by the rotational angle signal output from the gyro sensor 24, the acceleration indicated by the acceleration signal output from the acceleration sensor 16, the brightness indicated by the brightness signal output from the illumination sensor 23, and the proximity signal output from the proximity sensor 25.

Specifically, the state detector 122 detects that the screen 112 becomes the state faced down after the following: when the information processing apparatus 100 is turned over, as illustrated in FIG. 4, from the state in which the information processing apparatus 100 is placed on a desk and the like with the screen 112 facing up (i.e., the screen 112 is not faced down), the rotational angle signal output from the gyro sensor 24 indicates rotation of the information processing apparatus 100 by 180 degrees around the X-axis or the Y-axis, and the brightness value indicated by the brightness signal output from the illumination sensor 23 becomes equal to or less than a predetermined threshold.

The state detector 122 may detect that the screen 112 becomes the state faced down after the following: an acceleration signal output from the acceleration sensor 16 indicates acceleration in the negative direction of the Z-axis (i.e., the screen 112 faces up), then an acceleration signal indicates the acceleration in the rotational direction around the X-axis or the Y-axis, and then an acceleration signal indicates acceleration in the positive direction of the Z-axis (i.e., toward the front of the screen 112), and a brightness value indicated by the brightness signal output from the illumination sensor 23 becomes equal to or less than a predetermined threshold.

If the screen 112 is faced down onto an transparent plane such as a glass table, although a rotational angle signal indicates rotation of the information processing apparatus 100 by 180 degrees around the X-axis or the Y-axis, or an acceleration signal indicates acceleration in the positive direction of the Z-axis, a brightness value indicated by the brightness signal output from the illumination sensor 23 does not become equal to or less than a predetermined threshold, thus it cannot be determined that the screen 112 becomes the state faced down. In this respect, the state detector 122 detects that the screen 112 becomes the state faced down when a rotational angle signal indicates rotation of the information processing apparatus 100 by 180 degrees around the X-axis or the Y-axis, or an acceleration signal indicates acceleration in the positive direction of the Z-axis, and a proximity signal is output from the proximity sensor 25. This can enable detection of the state in which the screen 112 is faced down if the screen 112 is faced down onto a transparent plane such as a glass table.

The state detector 122 may also detect that the screen 112 becomes the state faced down after the following: a rotational angle signal output from the gyro sensor 24 indicates rotation of the information processing apparatus 100 by 180 degrees around the X-axis or the Y-axis, or an acceleration signal indicates the acceleration in the positive direction of the Z-axis, and a brightness value indicated by a brightness signal output from the illumination sensor 23 is lowered by a predetermined value. This can prevent erroneous detection of the state in which the screen 112 is faced down if the screen 112 is faced downward without being completely turned down onto a table and the like in a dark place where the brightness value is equal to or less than a predetermined threshold.

The locked-mode controller 123 functions as a controller that controls the information processing apparatus 100 to proceed to the security locked mode after the state detector 122 detects the state in which the screen 112 is faced down. The locked-mode controller 123 maintains the security locked mode when the information processing apparatus returns from the state in which the screen 112 is faced down to the state in which the screen 112 is not faced down. It should be noted that the security locked mode serves as a mode to prohibit output of various types of information from the information processing apparatus 100 so as to protect the various types of information. The security locked mode is a mode in which, for example, display content in the screen 112 is hidden and the screen is switched to an unlock screen for prompting a user to input an instruction (e.g., input a password or pattern) to release the security locked mode. This can enable transition to the security locked mode only by facing down the screen 112 of the information processing apparatus 100 when a user leaves without carrying the information processing apparatus 100 in the middle of viewing information displayed on the information processing apparatus 100, or when a user wants to prohibit others to view information displayed on the screen 112. This can provide a highly convenient user interface.

Specifically, as illustrated in FIG. 5, the locked-mode controller 123 continues a normal operation in which various applications are executed by the execution module 121 (S501) while the state of the screen 112 faced down is not detected by the state detector 122 (No at S502). The locked-mode controller 123 then controls the information processing apparatus 100 to proceed to the security locked mode (S503) when the state of the screen 112 faced down is detected (Yes at S502).

After the state of the screen 112 faced down is detected and the information processing apparatus 100 proceeds to the security locked mode and if a user performs no operation to release the security locked mode on the unlock screen within a predetermined time period, the locked-mode controller 123 in the embodiment controls the information processing apparatus 100, for example, to turn off the backlight of the screen 112 to stop displaying the unlock screen on the screen 112 so as to proceed to a not-in-use mode. After that, the locked-mode controller 123 maintains the not-in-use mode until any hardware key such as a home button (not illustrated) is pressed so that an instruction to exit the security locked mode is input. When the state of the screen 112 faced down is detected, the unlock screen is displayed on the screen 112 in the embodiment, however, the embodiment is not limited to this example. For another example, when the state of the screen 112 faced down is detected, the backlight of the screen 112 may be turned off so as to prohibit displaying information on the screen 112.

After the information processing apparatus 100 proceeds to the security locked mode, the locked-mode controller 123 determines whether the operation to release the security locked mode is performed in the unlock screen displayed on the screen 112 (S504). If the operation to release the security locked mode is not performed (No at S504), the locked-mode controller 123 returns processing to S503 so as to maintain the security locked mode although the information processing apparatus 100 returns from the state in which the screen is faced down to the state in which the screen is not faced down.

When the operation to release the security locked mode is performed in the unlock screen (Yes at S504), the locked-mode controller 123 controls the information processing apparatus to exit the security locked mode (S505). During this control, the locked-mode controller 123 controls the execution module 121 to execute a returning operation to a normal operation comprising reading the information (e.g., various settings relating to application execution) relating to the application exited due to transition to the security locked mode.

With reference to FIG. 3 again, the locked-mode controller 123 controls the execution module 121 to exit the application so as to hide the information displayed involved with application execution when the state detector 122 detects that the screen is faced down. During this control, the locked-mode controller 123 stores the information relating to the application executed when the state detector 122 detects the state in which the screen 112 is faced down (e.g., information involved with application execution, various settings relating to application execution) in the non-volatile memory 17 or other recording media.

The locked-mode controller 123 in the embodiment controls the information processing apparatus to exit the application when the state of the screen 112 faced down is detected, however, another example may be employed as long as the information displayed involved with application execution is hidden. For example, the locked-mode controller 123 may minimize the window of information displayed involved with application execution so as to hide the information. This can prevent information to be displayed first, which was displayed on the screen 112 before transition to the security locked mode and the user wants to prohibit others to view, when the information processing apparatus 100 releases the security locked mode.

The locked-mode controller 123 in the embodiment hides information displayed involved with application execution in response to detection of the state in which the screen 112 is faced down. Another example may be employed, however, as long as information displayed involved with application execution is hidden when the information processing apparatus 100 returns from the security locked mode. For example, after the information processing apparatus 100 proceeds to the security locked mode and any hardware key (not illustrated) comprised in the information processing apparatus 100 is pressed, the locked-mode controller 123 may exit the application or minimize the window of information displayed involved with application execution so as to hide the information.

The locked-mode controller 123 controls the information processing apparatus 100 to pause video replayed involved with application execution by the execution module 121 when the state detector 122 detects the state in which the screen 112 is faced down. During this control, the locked-mode controller 123 controls the information processing apparatus 100 to hide the display of the video replayed involved with application execution on the screen 112. This can resume the video replayed involved with application execution at the replay position when the state of the screen 112 faced down is detected, after releasing the security locked mode. This can also prevent leaking the display content of the paused video displayed on the screen 112 upon transition to the security locked mode. The locked-mode controller 123 in the embodiment controls the information processing apparatus 100 to pause the video replayed involved with application execution by the execution module 121 at a replay position traced back for a certain time required for transition to the state in which the screen is faced down from the replay position when the state of the screen faced down is detected. This can pause replay of the video in consideration of missing some scenes of the video replayed till the state of the screen 112 faced down is detected, whereby missing some scenes of the video when releasing the security locked mode can be avoided.

The locked-mode controller 123 controls the information processing apparatus to pause the audio replayed involved with application execution by the execution module 121 when the state of the screen faced down is detected while the audio replayed involved with application execution (e.g., music or speech) is output to the speakers 22. The locked-mode controller 123 in the embodiment pauses the audio replayed involved with application execution by the execution module 121, however, another example may be employed as long as output of audio replayed involved with application execution is stopped. For example, the locked-mode controller 123 may control the information processing apparatus to mute the audio replayed involved with application execution. This can stop output of audio more easily compared to operating a hardware or software volume key during the audio replayed involved with application execution. The locked-mode controller 123 in the embodiment also controls the information processing apparatus to pause the replay of the audio at a replay position traced back for a certain time required for transition to the state in which the screen is faced down from the replay position when the state of the screen faced down is detected. This can pause the replay of the audio in consideration of missing some sounds of the audio replayed till the screen 112 becomes the state faced down, whereby missing some sounds of the audio when releasing the security locked mode can be avoided.

The locked-mode controller 123 controls the information processing apparatus 100 to continue output of the audio replayed involved with application execution by the execution module 121 rather than muting the audio when the state of the screen faced down is detected while the audio is output to a pair of headphones or a pair of earphones. This can enable a user to listen to the audio after making the screen 112 face down so as to prohibit others to view information displayed on the screen 112. The locked-mode controller 123 also controls the information processing apparatus 100 to stop output of audio replayed involved with application execution when connection to the pair of headphones or the pair of earphones, which serves as output destination of the audio, is disconnected.

As described above, the information processing apparatus 100 in the embodiment comprises the display 11 comprising the screen 112, the state detector 122 that detects the state in which the screen 112 is faced down, and the locked-mode controller 123 that controls the information processing apparatus to proceed to the security locked mode when the state of the screen 112 faced down is detected and maintain the security locked mode when the information processing apparatus returns from the state in which the screen 112 is faced down to the state in which the screen 112 is not faced down. With this structure, transition to the security locked mode can be achieved by only turning down the screen 112, thereby providing a highly convenient user interface. In addition, if the information processing apparatus 100 is controlled to return from the state in which the screen is faced down to the state in which the screen is not faced down, the security locked mode is maintained. This can prevent leaking information that may be output from the information processing apparatus 100.

The computer program executed in the information processing apparatus 100 according to the embodiment is provided in a manner recorded as an installable or executable file format in a computer-readable recording medium, such as a compact disk read-only memory (CD-ROM), a flexible disk (FD), a compact disk recordable (CD-R), and a digital versatile disk (DVD).

The computer program above may be provided in a manner stored in a computer connected to a network such as the Internet so as to be downloaded through the network. The computer program above may also be provided or distributed over a network such as the Internet.

The computer program above may be provided in a manner installed in a read only memory (ROM) or other recording modules in advance.

The computer program above in the embodiment has a module structure comprising some of the modules described above (e.g., the execution module 121, the state detector 122, and the locked-mode controller 123). As the actual hardware structure, the CPU 12 reads the computer program from the recording medium to be executed, whereby some of the modules are loaded on a main storage module, so that the execution module 121, the state detector 122, and the locked-mode controller 123 are created on the main storage module.

Moreover, the various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An information processing apparatus comprising:
a display comprising a screen;
a detector configured to detect a first state of the screen when the screen is faced down; and
a controller configured to initiate a security locked mode when the first state is detected.

2. The information processing apparatus of claim 1, wherein the controller is configured to maintain the security locked mode when the information processing apparatus returns from the first state to a second state when the screen is not faced down.

3. The information processing apparatus of claim 1, wherein the controller is configured to hide information displayed by executing an application on the display to proceed to the security locked mode when the first state is detected.

4. The information processing apparatus of claim 3, wherein the controller is configured to exit the execution of the application to hide the information when the first state is detected.

5. The information processing apparatus of claim 3, wherein the controller is configured to pause video replayed by executing the application when the first state is detected.

6. The information processing apparatus of claim 5, wherein the controller is configured to pause video replayed by executing the application at a replay position traced back for a time required for transition to the first state from a replay position when the first state is detected.

7. The information processing apparatus of claim 3, further comprising:
a speaker, wherein
the controller is configured to stop output of audio replayed by executing the application when the first state is detected while the audio replayed by executing the application is output to the speaker.

8. The information processing apparatus of claim 7, wherein the controller is configured to pause audio replayed by executing the application.

9. The information processing apparatus of claim 8, wherein the controller is configured to pause audio replayed by executing the application at a replay position traced back for a time required for transition to the first state from a replay position when the first state is detected.

10. The information processing apparatus of claim 7, wherein the controller is configured to mute audio replayed by executing the application.

11. The information processing apparatus of claim 7, wherein the controller is configured to continue output of audio replayed by executing the application when the first state is detected while the audio replayed by executing the application is output to a headphone or an earphone.

12. The information processing apparatus of claim 11, wherein the controller is configured to stop output of audio replayed by executing the application when connection to the headphone or the earphone is disconnected.

13. The information processing apparatus of claim 1, wherein the controller is configured to display an unlock screen on the display for prompting a user to input an instruction to release the security locked mode when the first state is detected, and to release the security locked mode when the instruction is input in the unlock screen.

14. An information processing method comprising:
detecting a first state of a screen of a display in an information processing apparatus when the screen is faced down; and
controlling the information processing apparatus to proceed to a security locked mode when the first state is detected.

15. The information processing method of claim 14, wherein the controlling comprises controlling the information processing apparatus to maintain the security locked mode when the information processing apparatus returns from the first state to a second state when the screen is not faced down.

16. The information processing method of claim 14, wherein the controlling comprises controlling the information processing apparatus to hide information displayed by executing an application on the display to proceed to the security locked mode when the first state is detected.

17. A computer program product comprising a non-transitory computer readable medium comprising programmed instructions, wherein the instructions, when executed by a computer, cause the computer to perform:
detecting a first state of a screen of a display in an information processing apparatus when the screen is faced down; and
controlling the information processing apparatus to proceed to a security locked mode when the first state is detected.

18. The computer program product of claim 17, wherein the controlling comprises controlling the information processing apparatus to maintain the security locked mode when the information processing apparatus returns from the first state to a second state when the screen is not faced down.

19. The computer program product of claim 17, wherein the controlling comprises controlling the information processing apparatus to hide information displayed by executing an application on the display to proceed to the security locked mode when the first state is detected.
